(19) United States
(12) Patent Application Publication
(10) Pub. No.: US 2009/0196443 A1
(43) Pub. Date: Aug. 6, 2009

(54) WIRELESS EARPHONE SYSTEM WITH HEARING AID FUNCTION

(75) Inventors: Hong-Ching Her, Taichung (TW); Hung-Yue Chang, Taichung (TW); Ton-Kun Ho, Taichung (TW)

Correspondence Address: BROWDY AND NEIMARK, P.L.L.C.;624 NINTH STREET, NW, SUITE 300, WASHINGTON, DC, 20001-5303, US

(73) Assignee: Merry Electronics Co., Ltd., Taichung (TW)

(21) Appl. No.: 12/023,759

(22) Filed: Jan. 31, 2008

(51) Int. Cl. H04R 25/00

(52) U.S. Cl. 381/315

(57) ABSTRACT

A wireless earphone system includes a main device and two ear-hang devices. The main device having a digital signal processor, a server-end wireless transmitting module and a server-end wireless receiving module electrically connected with the digital signal processor respectively. Each ear-hang device has a microphone, a speaker, a client-end wireless transmitting module electrically connected to the microphone and a client-end wireless receiving module electrically connected to the speaker. The microphone collects an external sound wave and converts the external sound wave into an electronic signal for transmission to the digital signal processor by the client-end wireless transmitting module and the server-end wireless receiving module, and the processed electronic signal is transmitted by the server-end wireless transmitting module and the client-end wireless receiving module to the microphone for converting into a sound wave.

### BACKGROUND OF THE INVENTION

1. Field of the Invention

The present invention relates to earphones, and more particularly, to a wireless earphone system with hearing aid function to amplify and modulate sounds for the wearer.

2. Description of the Related Art

A hearing aid is an electro-acoustic body-worn apparatus which typically fits in or behind the wearer's ear, and is designed to amplify and modulate sounds for the wearer. Basically, a hearing aid includes a microphone for receiving sounds, an amplifier for amplifying and modulating received sounds, and a combination of earphone and ear-mold for outputting sounds to the wearer's eardrum.

For a hearing-impaired, the use of a hearing aid is to amplify conversation sounds. However, the sound spectrum of surrounding noises may be overlapped with the sound spectrum of conversation sounds. In this case, the hearing aid amplifies the surrounding noises while amplifying the conversation sounds, and the wearer may be unable to distinguish the conversation sounds from the noises. The interference of surrounding noises will make the hearing-impaired to feel uncomfortable.

Further, the hearing aid has a certain dimension and must be partially inserted into the wearer's ear canal to occupy a part of the space of the ear canal. Certain ear-mold of hearing aids covers the whole ear canal so that the ear of the hearing-impaired has no room to wear an extra earphone for hearing music or radio program.

Further, referring to Taiwan Patent 1277356 “Wireless system and method for hearing aid” teaches a wireless earphone system provided for a hearing-impaired. This design includes a receiver and two ear-hang devices. The receiver can be hung on the user's neck or put in the breast pocket to receive and convert external sounds and to transmit the converted sound signals to the two ear-hang devices wirelessly so that the user can hear external sounds. The purpose of the hearing aid is to reduce the ear-mold size in accordance with separation of the receiver from the ear-hang devices. However, a person identifies the direction of sounds by means of differences in the intensity of sounds heard by the two ears. When a hearing-impaired uses the receiver to collect external sounds, the receiver has only one receiving position. Because the receiver and the ear-hang devices are disposed at different locations, the user may confuse the direction of sounds. Further, when the location of the receiver is moved opposite to the two ear-hang devices, the information will be confused to be calculated by the receiver so that the user unable to make accurate identification of the direction of sounds.

In general, a hearing-impaired wearing a hearing aid cannot use an earphone set normally. Further, conventional hearing aids cannot eliminate the interference of surrounding noises and cannot help the user to identify the direction of sounds. Therefore, it is desirable to provide a wireless earphone system that eliminates the aforesaid problems.

### SUMMARY OF THE INVENTION

The present invention has been accomplished under the circumstances in view. It is an objective of the present invention to provide a wireless earphone system which has the function of a hearing aid and the function of an earphone set so as to bring convenience for a hearing-impaired.

It is another objective of the present invention to provide a wireless earphone system that utilizes a digital signal processor to provide a noise cancellation function, improving the receiving quality and hearing aid performance and, has a microphone integrated in an ear-hang device to match with the function of the digital signal processor for enabling the user to identify the direction of sounds accurately.

To achieve these objectives of the present invention, the wireless earphone system comprises a main device and two ear-hang devices. The main device comprises a digital signal processor, a server-end wireless transmitting module, and a server-end wireless receiving module. The digital signal processor is electrically connected with the server-end wireless transmitting module and the server-end wireless receiving module. Each of the ear-hang devices comprises a microphone, a speaker, a client-end wireless transmitting module and a client-end wireless receiving module. The client-end wireless transmitting module is electrically connected with the microphone. The client-end wireless receiving module is electrically connected with the speaker. The microphone collects external sound wave and converts external sound wave into an electronic signal. The client-end wireless transmitting module transmits the electronic signal from the microphone to the server-end wireless receiving module. The server-end wireless receiving module transmits the received electronic signal to the digital signal processor for processing. The digital signal processor transmits the processed electronic signal to the server-end wireless transmitting module for transmission to the speaker via the client-end receiving module for converting into a sound wave.

It is another objective of the present invention to provide a wireless earphone system that utilizes a bluetooth module to communicate with a mobile phone for conversation, or to receive music from an audio device.

To achieve the aforesaid objective, the wireless earphone system comprises a main device and at least one ear-hang device. The main device comprises a digital signal processor, a bluetooth module, a server-end wireless transmitting module, and a server-end wireless receiving module. The digital signal processor is electrically connected with the bluetooth module, the server-end wireless transmitting module and the server-end first wireless receiving module. The ear-hang device comprises a microphone, a speaker, a client-end wireless transmitting module, and a client-end wireless receiving module. The client-end wireless transmitting module is electrically connected with the microphone. The client-end wireless receiving module is electrically connected with the speaker. The server-end wireless transmitting module and server-end wireless receiving module of the main device and the client-end wireless transmitting module and client-end wireless receiving module of the ear-hang device are adapted to transmit electronic signals from the digital signal processor to the speaker for output and from the microphone to the digital signal process for processing. The bluetooth module is adapted to transmit an external electronic signal to the digital signal processor for processing, and to transmit the processed electronic signal from the digital signal processor to an external bluetooth interface.

By means of the aforesaid arrangement, the wireless earphone system of the present invention can be used as a hearing aid for a hearing-impaired as well as an ordinary wireless earphone set. It brings convenience to a hearing-impaired. By means of noise cancellation processing of the digital signal processor of the main device, the wireless earphone system provides high receiving quality. By means of integration of speakers in ear-hang devices and application of wireless transmission and digital signal processing, the wireless earphone system enables the hearing-impaired to identify the direction of sounds accurately. Further, by means of the bluetooth module, the wireless earphone system is practical for use with a mobile phone for two-way communication as well as for listening to music from an electronic apparatus.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWING

The present invention will become more fully understood from the detailed description given herein below and the accompanying drawings which are given by way of illustration only, and thus are not limitative of the present invention, and wherein:

FIG. 1 is a schematic drawing showing the architecture of a wireless earphone system in accordance with the present invention:

FIG. 2 is a schematic drawing showing the operation of the wireless earphone system when the wireless earphone system is used as a hearing aid;

FIG. 3 is a schematic drawing showing the operation of the wireless earphone system with a mobile phone for conversation, and

FIG. 4 is a schematic drawing showing the operation of the wireless earphone system for listening music.

### DETAILED DESCRIPTION OF THE INVENTION

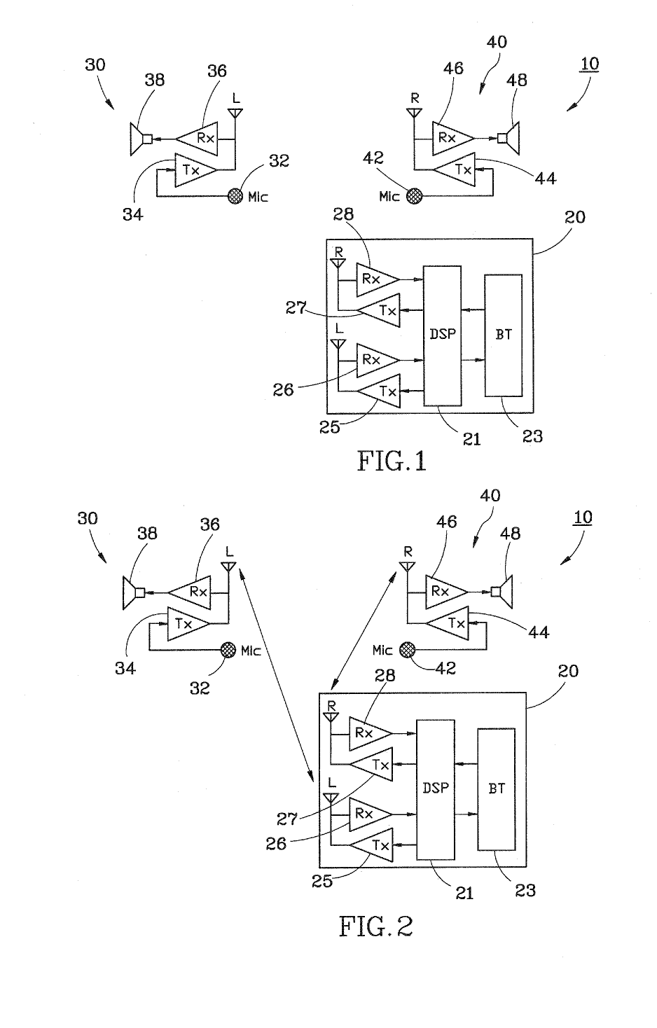

Referring to FIGS. 1 and 2, a wireless earphone system 10 in accordance with an exemplary embodiment of the present invention comprises a main device 20, a first ear-hang device 30, and a second ear-hang device 40.

The main device 20 includes a digital signal processor 21, a bluetooth module 23, a first server-end wireless transmitting module 25, a first server-end wireless receiving module 26, a second server-end wireless transmitting module 27, and a second server-end wireless receiving module 28. The digital signal processor 21 is electrically connected with the bluetooth module 23, the first server-end wireless transmitting module 25, the first server-end wireless receiving module 26, the second server-end wireless transmitting module 27 and the second server-end wireless receiving module 28. The digital signal processor 21 has at least filtering and amplification functions for processing electronic signals. The main device 20 is adapted for communication with a mobile phone (not shown) via the bluetooth module 23.

The first ear-hang device 30 includes a microphone 32, a first client wireless transmitting module 34, a first client wireless receiving module 36, and a speaker 38. The microphone 32 of the first ear-hang device 30 is adapted to collect external sound wave and to convert the sound wave into an electronic signal. The first wireless transmitting module 34 is electrically connected with the microphone 32 of the first ear-hang device 30 and adapted to transmit the electronic signal from the microphone 32 to the first server-end wireless receiving module 26 of the main device 20. The first client-end wireless receiving module 36 is adapted for receiving the electronic signal from the first server-end wireless transmitting module 25 of the main device 20. The speaker 38 of the first ear-hang device 30 is electrically connected with the first client-end wireless receiving module 36, and adapted to convert the electronic signal into a sound wave for output into the ear canal of a hearing-impaired.

The second ear-hang device 40 includes a microphone 42, a second client-end wireless transmitting module 44, a second client-end wireless receiving module 46, and a speaker 48. The microphone 42 of the second ear-hang device 40 is adapted to collect external sound wave and to convert the sound wave into an electronic signal. The second client-end wireless transmitting module 44 is electrically connected with the microphone 42 of the second ear-hang device 40 and adapted to transmit the electronic signal from the microphone 42 to the second server-end wireless receiving module 28 of the main device 20. The second client-end wireless receiving module 46 is adapted for receiving the electronic signal from the second server-end wireless transmitting module 27 of the main device 20. The speaker 48 of the second ear-hang device 40 is electrically connected with the second client-end wireless receiving module 46, and adapted to convert the electronic signal into a sound wave for output into the ear canal of the hearing-impaired.

Further, the transmission of signal between the main device 20 and a mobile phone is done by means of a bluetooth interface. However, the transmission interface between the main device 20 and the first ear-hang device 30/second ear-hang device 40 can be done by means of one of the transmission interfaces of infrared rays, radio frequency and bluetooth.

When the wireless earphone system 10 is used independently and not in communication with a mobile phone, it is used as an ordinary haring aid. When the microphone 32 of the first ear-hang device 30 and the microphone 42 of the second ear-hang device 40 collect external sound wave, the first ear-hang device 30 and the second ear-hang device 40 convert the sound wave into an electronic signal and transmit the electronic signal to the main device 20 for further processing by the main device 20, for example, filtering and amplification to remove noises from sounds. The main device 20 processes the electronic signal to remove noises from the sounds by means of the digital signal processor 21 so that the hearing-impaired will not feel uncomfortable when hearing the sounds. After processing through the digital signal processor 21, the main device 20 transmits the electronic signal to the first ear-hang device 30 and the second ear-hang device 40 for outputting into the ear canals of the hearing-impaired via the respective speakers 38 and 48. Further, because the first ear-hang device 30 and the second ear-hang device 40 are respectively hung on the left and right ears of the hearing-impaired to collect and output sounds, the hearing-impaired can identify the direction of sounds accurately, eliminating the drawback of misjudgment of sound direction of conventional hearing aids.

For fully understanding of the operation of the other functions of the wireless earphone system 10, please refer to the following description.

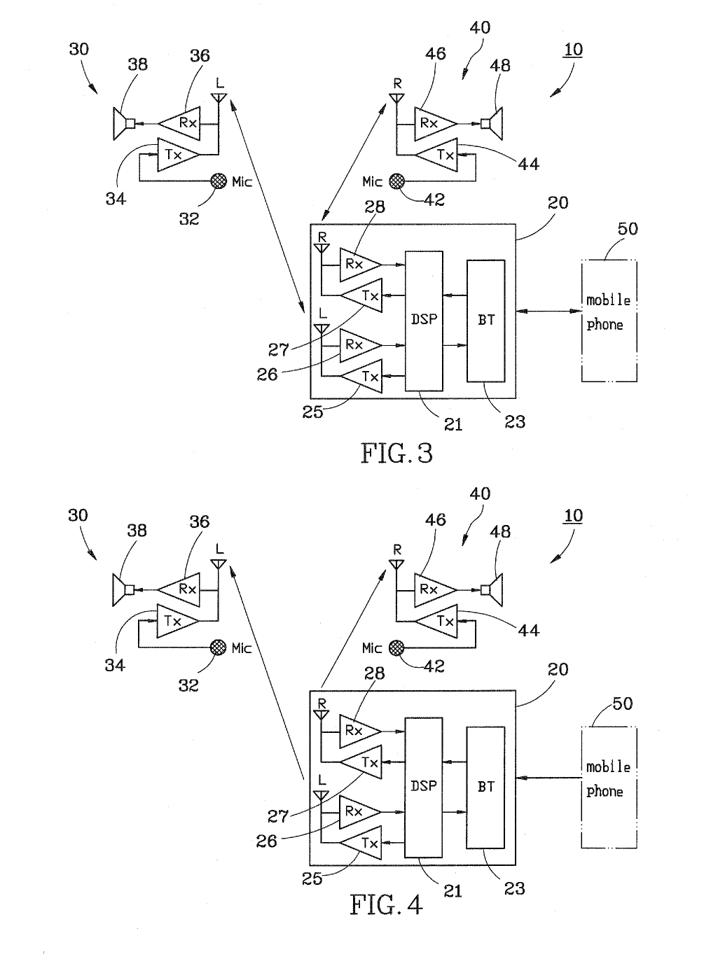

Referring to FIG. 3, when the hearing-impaired uses a mobile phone 50 to receive a phone call, the bluetooth module 23 of the main device 20 is in two-way communication with the mobile phone 50 for transmitting and receiving sounds. At this time, the digital signal processor 21 processes the electronic signal, and the main device 20 transmits the processed electronic signal to the first ear-hang device 30 and the second ear-hang device 40 for output into the ear canals of the hearing-impaired via the speaker 38 and 42 so that the hearing-impaired will hear the phone call accurately. During the receiving mode of the mobile phone 50, it is sufficient to use one of the speaker 38 of the first ear-hand device 30 and the speaker 42 of the second ear-hang device 40 for voice output. According to the present preferred embodiment, the speaker 38 of the first ear-hand device 30 and the speaker 42 of the second ear-hang device 40 are simultaneously used for voice output as the hearing-impaired is using mobile phone 50 to receive a phone call.

Therefore, the hearing-impaired needs not to remove the wireless earphone system 10 and then to wear a hear aid. The hearing-impaired can use the wireless earphone system 10 to assist hearing and to receive a phone call.

Referring to FIG. 4, when the hearing-impaired uses a mobile phone 50 to listen to music, for example MP3 files, the main device 20 utilizes the bluetooth module 23 to communicate with the mobile phone 50. At this time, the music file is transmitted to the main device 20 via the bluetooth module 23 by means of one-way transmission, and then processed by the digital signal processor 21 subject required from the hearing-impaired. The main device 20 transmits the processed electronic signal to the first ear-hang device 30 and the second ear-hang device 40 for output into the ear canals of the hearing-impaired via the speaker 38 of the first ear-hand device 30 and the speaker 42 of the second ear-hang device 40 respectively, and therefore the wireless earphone system 10 provides high quality stereo sound effects for the hearing-impaired. Further, it is to be understood that any audio device capable of playing music and provided with a bluetooth interface can be used with the wireless earphone system 10. For example, the wireless earphone system 10 can be used with a notebook computer with Bluetooth interface.

In conclusion, the wireless earphone system of the present invention can be used as a hearing aid for a hearing-impaired as well as an ordinary wireless earphone set. By means of noise cancellation processing of the digital signal processor of the main device, the wireless earphone system provides high receiving quality. By means of integration of speakers in ear-hang devices and application of wireless transmission and digital signal processing, the wireless earphone system enables the hearing-impaired to identify the direction of sound accurately. Further, by means of the bluetooth module, the wireless earphone system is practical for use with a mobile phone for two-way communication as well as for listening to music from an electronic apparatus.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A wireless earphone system comprising:
a main device having a digital signal processor, a server-end wireless transmitting module and a server-end wireless receiving module, the digital signal processor being electrically connected with the server-end wireless transmitting module and the server-end first wireless receiving module; and
two ear-hang devices, each of which includes a microphone, a speaker, a client-end wireless transmitting module and a client-end wireless receiving module, the client-end wireless transmitting module being electrically connected with the microphone, the client-end wireless receiving module being electrically connected with the speaker;
wherein the microphones collect external sound wave and convert the external sound wave into an electronic signal; the client-end wireless transmitting modules transmit the electronic signal from the microphones to the server wireless receiving module; the server-end wireless receiving module transmits the electronic signal to the digital signal processor for processing; the digital signal processor transmits the processed electronic signal to the server-end wireless transmitting module for transmission to the speakers via the client-end receiving modules for converting into sound wave.

2. The wireless earphone system as claimed in claim 1, wherein the digital signal processor has at least one of the functions of filtering and amplification.

3. The wireless earphone system as claimed in claim 1, wherein the transmission interface between the main device and the ear-hang devices is one of the transmission interfaces of infrared rays, radio frequency and bluetooth.

4. The wireless earphone system as claimed in claim 1, wherein the main device further comprises a bluetooth module for communication with a mobile phone.

5. The wireless earphone system as claimed in claim 1, wherein the main device further comprises a bluetooth module for receiving music from an external audio source.

6. The wireless earphone system as claimed in claim 5, wherein the audio device is one of a mobile phone and a notebook computer.

7. A wireless earphone system comprising:
a main device having a digital signal processor, a bluetooth module, a server wireless transmitting module and a server-end wireless receiving module, the digital signal processor being electrically connected with the bluetooth module, the server wireless transmitting module and the server-end wireless receiving module; and
at least one ear-hang device having a microphone, a speaker, a client-end wireless transmitting module and a client-end wireless receiving module, the client-end wireless transmitting module being electrically connected with the microphone, the client-end wireless receiving module being electrically connected with the speaker;
wherein the server-end wireless transmitting module and server-end wireless receiving module of the main device, and the client-end wireless transmitting module and client-end wireless receiving module of the ear-hang device are adapted to transmit electronic signals from the digital signal processor to the speaker and from the microphone to the digital signal process; the bluetooth module is adapted to transmit an external electronic signal to the digital signal processor for processing, and to transmit the processed electronic signal from the digital signal processor to an external bluetooth interface.

8. The wireless earphone system as claimed in claim 7, wherein the digital signal processor has at least one of the functions of filtering and amplification.

9. The wireless earphone system as claimed in claim 7, wherein the transmission interface between the main device and the ear-hang devices is one of the transmission interfaces of infrared rays, radio frequency and bluetooth.

10. The wireless earphone system as claimed in claim 7, wherein the main device is adapted to communicate with a mobile telephone by the bluetooth module.

11. The wireless earphone system as claimed in claim 7, wherein the main device is adapted to receive music from an external audio device by the bluetooth module.

12. The wireless earphone system as claimed in claim 11, wherein the external audio device is a mobile phone or a notebook computer.
